(19) United States
(12) Patent Application Publication
(10) Pub. No.: US 2003/0177052 A1
(43) Pub. Date: Sep. 18, 2003

(54) Human resources management system and method

(76) Inventors: William W. Smith III, Denver, CO (US); Jerry J. Pokorny, Denver, CO (US); Clay A. Anselmo, Golden, CO (US)

Correspondence Address: Lee Hsu, BROBECK, PHLEGER & HARRISON LLP, 12390 El Camino Real, San Diego, CA, 92130, US

(21) Appl. No.: 10/328,788

(22) Filed: Dec. 24, 2002

Related U.S. Application Data
(60) Provisional application No. 60/363,934, filed on Mar. 12, 2002.

(51) Int. Cl. G06F 17/60

(52) U.S. Cl. 705/9

(57) ABSTRACT

A method of human resources management is provided to allow an employer with excess available employee resources to loan one or more employees to another employer with need for additional employees in an efficient manner by avoiding the costly conventional processes of laying off excess employees or hiring new employees. In an embodiment, the method of human resources management is implemented in a web-based computer system which allows employers to search for available employees with appropriate qualifications and fill their employment needs quickly and efficiently.

### CROSS-REFERENCE TO RELATED APPLICATION

This application claims the benefit of U.S. Provisional Application Serial No. 60/363,934, filed Mar. 12, 2002, the contents of which are incorporated herein by reference.

### BACKGROUND OF THE INVENTION

1. Field of the Invention

The present invention relates to management and optimization of human resources, and more particularly, to web-based automated management of human resources.

2. Background Art

It is well known that employers may upsize the number of employees by creating permanent or temporary positions or downsize the number of employees either through layoff or elimination of temporary positions to scale down the workforce and overhead costs depending upon the market conditions or company-specific resource needs. In a market condition in which the available labor pool is scarce, employers are often unable to fill vacant positions within a reasonable amount of time to satisfy the business demand. On the other hand, in a market condition in which employers must downsize the employee base through layoffs or through the elimination of temporary positions, the employers will lose access to employees with important skill sets and expose them to increased employment risks. In addition, the employer's ability to secure additional business may be compromised due to capacity limitations. When the economy turns around at a later time, the employees who have been laid off are likely to have found other jobs and would not return to their previous employers. Therefore, there is a need for a more efficient method of allowing different employers to actively share employee resources between companies and to utilize these employee resources more efficiently, while decreasing the risk of unemployment for their employees and minimizing costs associated with training and recruitment.

### SUMMARY OF THE INVENTION

The present invention provides a human resource management method, generally comprising the steps of:

receiving employer information on a plurality of employers;

storing the employer information in an employer database;

receiving employee information on a plurality of employees, the employee information comprising employee qualifications, availability, and location;

storing the employee information in an employee database;

receiving at least one search criterion from one of the employers;

searching the employee database to find at least one of the employees matching said at least one search criterion; displaying at least one searched result based on a match of said at least one search criterion and the employee qualification; and

sending a notice of said at least one search result to an assigned representative of the owner or operator of the website.

Advantageously, the method according to embodiments of the present invention provides a formal, automated process for the “lending” or “seconding” of employees by a company with excess employee resources to another company with a need to expand its employee base in a time-efficient and cost-effective manner. The method according to embodiments of the present invention allows a company with a need for human resources to “borrow” one or more employees from another company with excess resources to achieve better employee utilization and lower overall cost. Furthermore, the method according to embodiments of the present invention is capable of reducing the need for companies to lay off permanent employees or to use temporary employees as means for controlling overall manpower and thus better management of their overall payroll and the associated overhead costs, by greatly increasing the companies' workforce flexibility and limiting employment liability.

### BRIEF DESCRIPTION OF THE DRAWINGS

The present invention will be described with particular embodiments thereof, and references will be made to the drawings in which:

FIG. 1 is a flow chart illustrating an embodiment of a method of human resources management according to the present invention; and

FIG. 2 is a flow chart continuing from the flow chart of FIG. 1 illustrating the embodiment of the method of human resources management according to the present invention; and

FIG. 3 is a block diagram illustrating a computer system for performing the method of human resources management in an embodiment according to the present invention.

### DETAILED DESCRIPTION

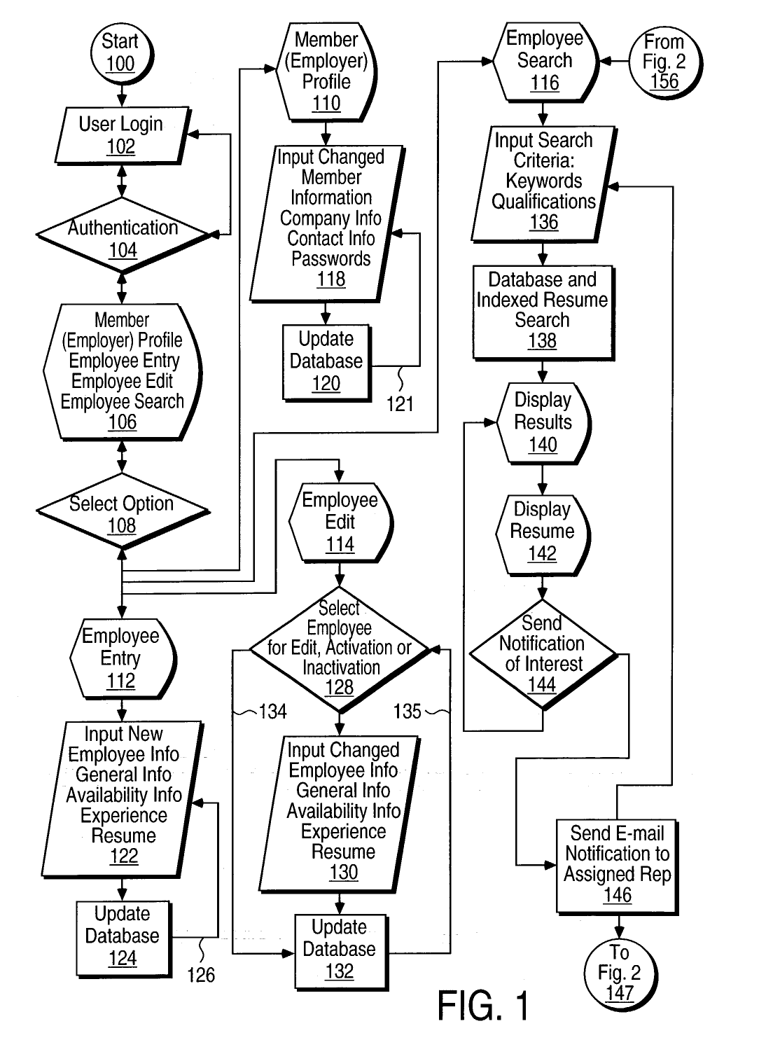

FIG. 1 is a flow chart illustrating an embodiment of the present invention, which includes an automated process that runs on a web-based platform for loaning employees from one company with excess human resources to another company which has an immediate demand for human resources. In this embodiment, the automated process allows the employers who have joined as members of an employment consortium either to lend employee resources to other consortium members or to acquire employee resources from other consortium members. As illustrated in FIG. 1, an employer who is a member of the employer consortium starts the automated process as indicated by block 100 by opening a website on a web browser, for example, www.seconding.net, and log onto a secured user website as indicated by block 102 by entering the user name and the password which are unique to that employer.

A web server which runs the website receives a user login including the user name and the password and in response authenticates the user login as indicated by block 104. After the user login is authenticated, a home screen is presented to the user to allow the user to select the options of changing existing employer information, inputting new employee information, changing existing employee information and starting employee search, as indicated by block 106. After the user selects one of the options as indicated by block 108, the server will allow the user to edit the member company or employer profile 110, to enter new employee information 112, to edit existing employee information, or to start employee search 116, depending on the option selected by the user.

If the option of editing member company profile is selected by the user as indicated by block 110, the user may input changed employer information including but not limited to employer contact information, type of industry, technical specialty and user password, for example, as indicated by block 118. The changed employer information is received by the computer system to update the employer database as indicated by block 120 in FIG. 1. The user may further edit the employer information as indicated by a feedback loop 121 until the editing is complete.

If the option of entering new employee information is selected as indicated by block 112, the user is allowed to enter new employee information, including but not limited to employee contact information, availability information, work experience, education and resume, for example, as indicated by block 122. Upon receiving the new employee information, the computer system updates the employee database as indicated by block 124. More than one employee may be added to the employee database by repeatedly entering new employee information and updating the employee database as indicated by a feedback loop 126 between blocks 122 and 124 in FIG. 1.

If the option of editing existing employee information is selected by the user as indicated by block 114, the user is then given the option of selecting one of the existing employees in the employee database for editing, activation or inactivation, as indicated by block 128. After the particular employee is selected, the user is allowed to input changed employee information including but not limited to employee contact information, availability information, work experience, education and resume, for example, as indicated by block 130. Upon receiving the changed employee information, the computer system updates the employee database as indicated by block 132. Employee information for more than one existing employee may be changed and the availability information may be updated by the user as indicated by the feedback loops 134 and 135 in FIG. 1. In an embodiment, the employee information for each of the employees comprises the employee's work experience and education which may be presented in a standardized or customized resume format.

If the option of starting employee search is selected by the user as indicated by block 116, the user is allowed to input one or more search criterion as indicated by block 136. The search criteria that are entered into the computer system for employee search may be entered by a variety of means, for example, by using key words, a combination of key words with Boolean expressions, pull-down menus, or hyperlinks. The search criteria may include required employee qualifications including but not limited to work experience and education. In an embodiment, only those employees which are marked as available and not inactivated are searched from the employee database to determine whether the employee qualifications match the search criteria of the employer who is conducting the employee search, as indicated by block 138.

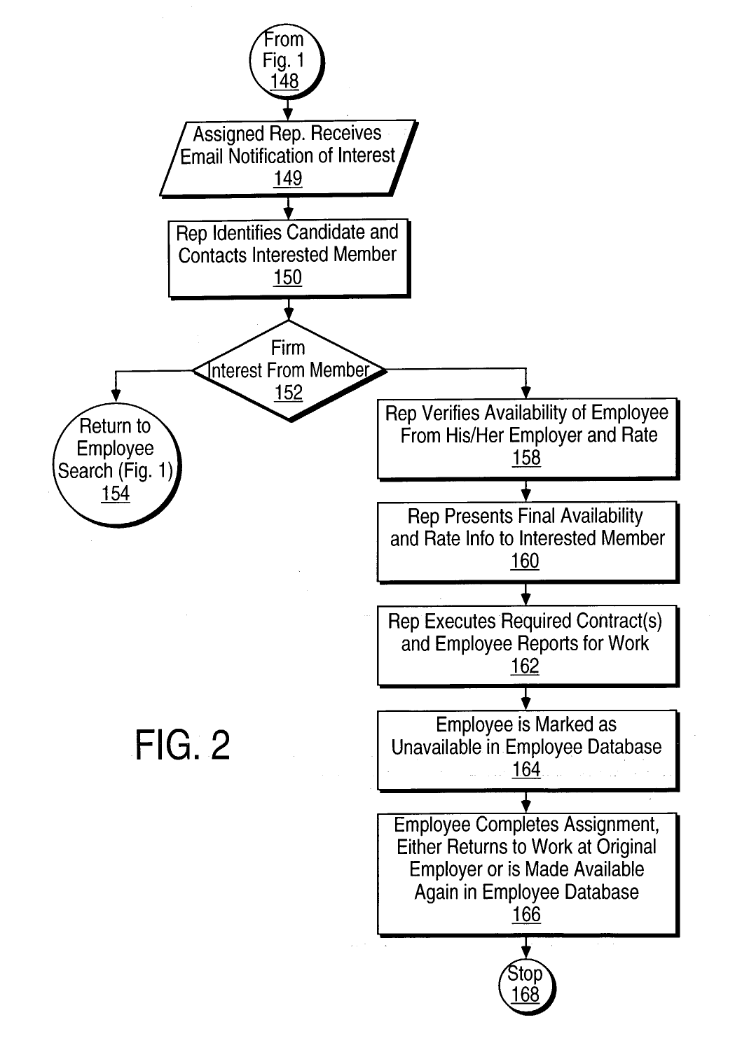

In an embodiment, the resumes of the available employees whose qualifications match the search criteria of the employer are indexed in a manner chosen by the employer and the search results are displayed on the web browser as indicated by block 140. The employer or user who has conducted the search may order the system to display the resume of any of the available employees whose qualifications match the search criteria as indicated by block 142. After reviewing the resume, the employer or user may send a notification of interest in one of the available employees whose qualifications match the search criteria by the web browser as indicated by block 144. In an embodiment, the notification may be sent in the form of an e-mail 146 to an assigned representative of the owner or operator of the website, and the flow chart continues to FIG. 2 as indicated by block 147.

FIG. 2 is a flow chart illustrating additional process steps in connection with the process steps illustrated in FIG. 1. Continuing from FIG. 1 as indicated by block 148, the assigned representative receives the e-mail notification of interest as indicated by block 149, and upon receipt of the e-mail, identifies the prospective employee and contacts the interested member company or employer as indicated by block 150. The member company is then requested to indicate whether it -has a firm interest in the employee candidate that it has selected as indicated by block 152. If the member company has not indicated that it has a firm interest in the candidate, it may return to the employee search website for more search functions as indicated by block 154 in FIG. 2. The process then flows back to block 156 in FIG. 1, to allow the member company to start a new employee search as indicated by block 116.

Referring back to FIG. 2, if the member company has indicated a firm interest in the selected employee candidate, the member company informs the assigned representative, and the representative verifies the availability of the employee candidate from his or her present employer and the rate for “borrowing” this employee, as indicated by block 158 in FIG. 2. After the verification, the representative presents the final availability and rate information to the member company which is interested in “borrowing” the employee from his or her present employer as indicated by block 160. The representative then executes the required contract(s) and the employee reports for work as indicated by block 162. The employee is marked as unavailable in the employee database as indicated by block 164, and remains unavailable until the employee completes the assignment with the new employer. After the employee completes the assignment, he or she may return to work at the original employer or marked as available after completing the assignment in the employee database as indicated by block 166. At all times during an assignment at another employer, the resource remains the employee of the lending employer. The “seconding” process for this job assignment is thus complete as indicated by block 168.

In an embodiment, the employee information including the employee contact information such as addresses, telephone and facsimile numbers, e-mail addresses, work experience and education may be presented in a standardized resume format. The resumes of the employees in the employee database can be created on the website, or pre-existing files can be uploaded by the employees. The duration of each assignment may vary according to the need of the employers and the availability of the employees. Furthermore, the rates charged for an employee may vary from assignment to assignment depending upon the job market conditions and the particular requirements of each assignment. In fluctuating job markets, the available pool of employee resources in the employee database may vary due to the addition of new employees, removal of existing employees and the loaning of employees from one member company to another.

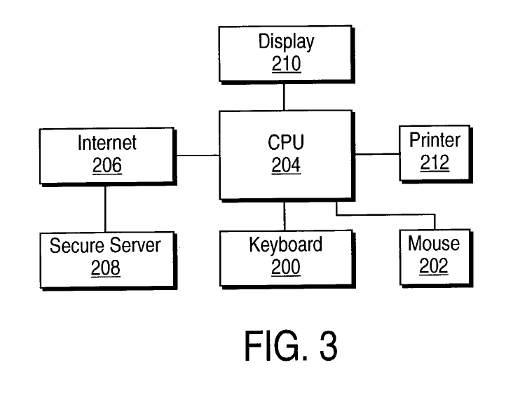

FIG. 3 is a simplified block diagram illustrating a computer system or an article of manufacture for a web-based search tool which allows member companies or employers to post available employees and loan them to other members, or search for available employees to fill their additional labor requirements. A member company or employer may use standard personal computer input devices such as a keyboard 200 and a mouse 202 which are connected to a central processing unit (CPU) 204 of the computer.

The member company may access the website through the internet 206 to a secure server 208, which includes the employee and employer databases and is capable of searching the employee database for available employees with qualifications that satisfy the search criteria entered by the member company. The search results may be displayed on a computer monitor or display 210 and printed on the printer 212.

The computer system as illustrated in FIG. 3 may also be used by the owner or operator of the website to add employee information for new employees into the employee database, to update employee information for existing employees, or to change the information for member companies in the employer database. The employee information is stored in a secure, indexed database that can be searched by properties or key words.

When a member company requires additional human resources, it may simply enter search parameters or criteria for the available position, and the secure server 208 will search employee attribute information stored in the database, or perform a key word search on the resumes and return the results in an easily viewable format. The member company can then indicate that it is interested in “borrowing” one or more available employees. In an embodiment, the secure server 208 generates an e-mail message to an assigned representative to indicate that the member company has an interest in a specific employee in the employee database. The representative then confirms that the member company has a firm interest in the specific employee and sets up the transaction to loan the employee to the member company.

In an embodiment, the member company which has borrowed the employee is responsible to pay for the salary and the benefit costs associated with the borrowed employee, and the owner or operator of the website acts as a broker for the transaction and charges a fee to facilitate the process. Other arrangements may also be implemented in various manners within the scope of the present invention. For example, an arrangement may be made between the borrowing company and the lending company in which the borrowing company pays the lending company an amount of money which includes the salary, benefit costs as well as overhead costs associated with lending the employee and pays the owner or operator of the website a transaction fee. In this case, the lending company is responsible for the employee's salary and benefit costs.

In addition to the efficient transfer of employees from employers with excess employee resources to employers with need for additional employees, thereby mitigating the need for layoffs and costly hiring processes, the human resources management system and method according to embodiments of the present invention greatly increase the workforce flexibility of the employers while limiting employment liability. For the employees, the possibility of loaning employees between different employers improves job stability by reducing the risk of unemployment. Furthermore, employees may have additional opportunities of working on various assignments with various employers, thereby increasing their knowledge and experience and making themselves more marketable in the future.

Various embodiments and detailed implementations may be contemplated within the scope of the present invention. For example, the human resources management system may include a function whereby after a certain number of days during which an employee has been listed as available, the system sends a notification to the user who entered the employee availability information that the user needs to renew the availability of the employee. If the user does not renew the employee's availability, the system will automatically mark the employee as unavailable. With this function, the human resources management system forces the users or member companies to keep the list of available employee resources up to date.

Various financial arrangements can also be made between the broker, which is the owner or operator of the website, the member company which is borrowing an employee, and the member company which is lending the employee. In one embodiment, the financial arrangement between the broker, the borrowing company and the lending company is such that the broker is responsible for billing the borrowing company and paying the lending company. Furthermore, part of the contractual obligations of each party in the transaction of lending and borrowing employee resources may include respect for confidentiality and proprietary information and non-solicitation of employees. These contractual obligations may be formalized as covenants of “fair play,” and financial penalties may be assessed on any party for non-compliance.

Various schemes of protecting the information obtained, compiled and stored by the broker, which is the owner or operator of the website, and protecting the broker's revenue stream may also be contemplated within the scope of the present invention. For example, the true identity and employer of any human resource available for lending may be protected and kept confidential until the borrowing company is contacted and the interest level of the borrowing company is determined. In addition, the identity of the borrowing company may also be kept confidential until the final stage of the borrowing process. The purpose of such schemes is to prevent employers from stealing the resources indirectly without participating in the “seconding” process brokered by the owner or operator of the website and to protect general hiring information about participants in the “seconding” network.

From the above description of embodiments of the present invention, it is manifest that various equivalents can be used to implement the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are to be considered in all respects as illustrative and not restrictive. It should also be understood that the invention is not limited to the particular embodiments described herein, but is capable of many equivalents, rearrangements, modifications, and substitutions without departing from the scope of the invention as set forth in the claims.

What is claimed is:

1. A human resource management method, comprising the steps of:
receiving employer information on a plurality of employers;
storing the employer information in an employer database;
receiving employee information on a plurality of employees, the employee information comprising employee qualification;
storing the employee information in an employee database;
receiving at least one search criterion from one of the employers;
searching the employee database to find at least one of the employees matching said at least one search criterion;
displaying at least one searched result based on a match of said at least one search criterion and the employee qualification; and
sending a notice of said at least one search result to an assigned representative.

2. The method of claim 1, further comprising the steps of:
receiving changed employer information on at least one of the employers selected for change; and
updating the employer database.

3. The method of claim 1, further comprising the steps of:
receiving new employee information on at least one additional employee; and
updating the employee database.

4. The method of claim 1, further comprising the steps of:
receiving changed employee information on at least one of the employees selected for change; and
updating the employee database.

5. The method of claim 1, wherein the employee qualification of each of the employees is presented by a resume.

6. The method of claim 1, further comprising the step of indexing a plurality of resumes of the employees matching said at least one search criterion.

7. The method of claim 6, further comprising the step of displaying the resumes of the employees matching said at least one search criterion.

8. The method of claim 6, further comprising the step of receiving confirmation that one of the employees matching said at least one criterion is selected for the employer who entered said at least one search criterion.

9. The method of claim 8, further comprising the step of marking the selected employee as unavailable.

10. The method of claim 9, further comprising the step of marking the selected employee as available after completing an assignment.

11. The method of claim 1, further comprising the steps of:
receiving a user login; and
authenticating the user login.

12. The method of claim 11, further comprising the step of presenting a home screen.

13. The method of claim 12, further comprising the step of presenting a plurality of options for user selection, the options comprising changing employer information, inputting new employee information, changing employee information and starting employee search.

14. The method of claim 1, wherein the employer information comprises employer contact information.

15. The method of claim 1, wherein the employee qualification comprises experience.

16. The method of claim 1, wherein the employee qualification comprises education.

17. A computer readable medium comprising a plurality of instructions, which when executed by a computer, cause the computer to perform the steps of:
receiving employer information on a plurality of employers;
storing the employer information in an employer database;
receiving employee information on a plurality of employees, the employee information comprising employee qualification;
storing the employee information in an employee database;
receiving at least one search criterion from one of the employers;
searching the employee database to find at least one of the employees matching said at least one search criterion;
displaying at least one searched result based on a match of said at least one search criterion and the employee qualification; and
sending a notice of said at least one search result to an assigned representative of the owner or operator of the website.

18. The computer readable medium as set forth in claim 17, further comprising instructions which cause the computer to perform the steps of:
receiving changed employer information on at least one of the employers selected for change; and
updating the employer database.

19. The computer readable medium as set forth in claim 17, further comprising instructions which cause the computer to perform the steps of:
receiving new employee information on at least one additional employee; and
updating the employee database.

20. The computer readable medium as set forth in claim 17, further comprising instructions which cause the computer to perform the steps of:
receiving changed employee information on at least one of the employees selected for change; and
updating the employee database.

21. The computer readable medium-as set forth in claim 17, wherein the employee qualification of each of the employees is presented by a resume.

22. The computer readable medium as set forth in claim 17, further comprising instructions which cause the computer to perform the step of indexing a plurality of resumes of the employees matching said at least one search criterion.

23. The computer readable medium as set forth in claim 22, further comprising instructions which cause the computer to perform the step of displaying the resumes of the employees matching said at least one search criterion.

24. The computer readable medium as set forth in claim 22, further comprising instructions which cause the computer to perform the step of receiving confirmation that one of the employees matching said at least one search criterion is selected for the employer who entered said at least one search criterion.

25. The computer readable medium as set forth in claim 24, further comprising instructions which cause the computer to perform the step of marking the selected employee as unavailable.

26. The computer readable medium as set forth in claim 25, further comprising instructions which cause the computer to perform the step of marking the selected employee as available after completing an assignment.

27. The computer readable medium as set forth in claim 17, further comprising instructions which cause the computer to perform the steps of:
receiving a user login; and
authenticating the user login.

28. The computer readable medium as set forth in claim 27, further comprising instructions which cause the computer to perform the step of presenting a home screen.

29. The computer readable medium as set forth in claim 28, further comprising instructions which cause the computer to perform the step of presenting a plurality of options for user selection, the options comprising changing employer information, inputting new employee information, changing employee information and starting employee search.

30. The computer readable medium as set forth in claim 17, wherein the employer information comprises employer contact information.

31. The computer readable medium as set forth in claim 17, wherein the employee qualification comprises experience.

32. The computer readable medium as set forth in claim 17, wherein the employee qualification comprises education.

33. An article of manufacture, including a computer readable medium having computer readable program code means embodied therein, the computer readable program code means in the article of manufacture comprising:
computer readable program code means for receiving employer information on a plurality of employers;
computer readable program code means for storing the employer information in an employer database;
computer readable program code means for receiving employee information on a plurality of employees, the employee information comprising employee qualification;
computer readable program code means for storing the employee information in an employee database;
computer readable program code means for receiving at least one search criterion from one of the employers;
computer readable program code means for searching the employee database to find at least one of the employees matching said at least one search criterion;
computer readable program code means for displaying at least one searched result based on a match of said at least one search criterion and the employee qualification; and
computer readable program code means for sending a notice of said at least one search result to an assigned representative.

34. The article of manufacture as set forth in claim 33, wherein the computer readable program code means further comprises:
computer readable program code means for receiving changed employer information on at least one of the employers selected for change; and
computer readable program code means for updating the employer database.

35. The article of manufacture as set forth in claim 33, wherein the computer readable program code means further comprises:
computer readable program code means for receiving new employee information on at least one additional employee; and
computer readable program code means for updating the employee database.

36. The article of manufacture as set forth in claim 33, wherein the computer readable program code means further comprises:
computer readable program code means for receiving changed employee information on at least one of the employees selected for change; and
computer readable program code means for updating the employee database.

37. The article of manufacture as set forth in claim 33, wherein the employee qualification of each of the employees is presented by a resume.

38. The article of manufacture as set forth in claim 33, wherein the computer readable program code means further comprises computer readable program code means for indexing a plurality of resumes of the employees matching said at least one search criterion.

39. The article of manufacture as set forth in claim 38, wherein the computer readable program code means further comprises computer readable program code means for displaying the resumes of the employees matching said at least one search criterion.

40. The article of manufacture as set forth in claim 38, wherein the computer readable program code means further comprises computer readable program code means for receiving confirmation that one of the employees matching said at least one search criterion is selected for the employer who entered said at least one search criterion.

41. The article of manufacture as set forth in claim 40, wherein the computer readable program code means further comprises computer readable program code means for marking the selected employee as unavailable.

42. The article of manufacture as set forth in claim 41, wherein the computer readable program code means further comprises computer readable program code means for marking the selected employee as available after completing an assignment.

43. The article of manufacture as set forth in claim 33, wherein the computer readable program code means further comprises:
computer readable program code means for receiving a user login; and
computer readable program code means for authenticating the user login.

44. The article of manufacture as set forth in claim 43, wherein the computer readable program code means further comprises computer readable program code means for presenting a home screen.

45. The article of manufacture as set forth in claim 44, wherein the computer readable program code means further comprises computer readable program code means for presenting a plurality of options for user selection, the options comprising changing employer information, inputting new employee information, changing employee information and starting employee search.

46. The article of manufacture as set forth in claim 33, wherein the employer information comprises employer contact information.

47. The article of manufacture as set forth in claim 33, wherein the employee qualification comprises experience.

48. The article of manufacture as set forth in claim 33, wherein the employee qualification comprises education.
